(19) United States
(12) Patent Application Publication
(10) Pub. No.: US 2021/0294854 A1
(43) Pub. Date: Sep. 23, 2021

(54) MERGING OF GRAPHS

(71) Applicant: Thomas Stuempfig, Nettetal (DE)

(72) Inventor: Thomas Stuempfig, Nettetal (DE)

(21) Appl. No.: 17/205,093

(22) Filed: Mar. 18, 2021

(30) Foreign Application Priority Data
Mar. 19, 2020 (EP) 20164259.2

(51) Int. Cl. G06F 16/901; G06F 16/28; G06F 21/44

(52) U.S. Cl. CPC G06F 16/9024; G06F 21/44; G06F 16/28

(57) ABSTRACT

A computer-implemented method including provision of at least two subgraphs, merging the at least two subgraphs to form a complete graph on the basis of at least one merging rule, wherein, when merging the at least two subgraphs on the basis of the at least one merging rule, a version of the merging rule is stored.

### CROSS REFERENCE TO RELATED APPLICATIONS

This patent document also claims the benefit of EP 20164259.2 filed on Mar. 19, 2020 which is hereby incorporated in its entirety by reference.

### BACKGROUND

The creation of complete graphs from subgraphs enables the structured evaluation of large quantities of data. It is regularly no longer possible, however, to deduce from the created complete graphs the manner in which they have been formed from the subgraphs.

### BRIEF SUMMARY AND DESCRIPTION

The scope of the present application is defined solely by the appended claims and is not affected to any degree by the statements within this summary. The present embodiments may obviate one or more of the drawbacks or limitations in the related art.

Embodiments provide a computer-implemented method, with which at least two subgraphs are merged to form a complete graph in a retrospectively retraceable manner.

A computer-implemented method is provided. The method includes the provision of at least two subgraphs. The at least two subgraphs are merged to form a complete graph on the basis of at least one merging rule. The method includes where when merging the at least two subgraphs on the basis of the at least one merging rule, a version of the merging rule is stored.

In one embodiment, the provision of the at least two subgraphs includes the preparation of raw data.

The provision of the at least two subgraphs may include the authorization of an access to the subgraphs.

The authorization of an access may include the use of a Security Assertion Markup Language (SAML).

Likewise, the provision of the at least two subgraphs may include the provision of the at least two subgraphs to an authenticated user.

In an embodiment of the method, the provision of the at least two subgraphs may include the provision of the at least two subgraphs in the form of stateless REST Web Service methods with JSON-LD.

The complete graph may be stored in a semantic database.

The at least one merging rule may be provided by a dedicated automatic rule system.

The preparation of raw data may include the creation of a semantic description of the raw data.

Further proposed is a system for data processing, that is configured to carry out the method, for example in accordance with one of the embodiments indicated in the foregoing.

### BRIEF DESCRIPTION OF THE FIGURES

In the following, the disclosed subject matter is explained in further detail, taking into consideration the drawings. In the figures, illustrated by way of example:

FIG. 1 depicts an authorization and authentication according to an embodiment.

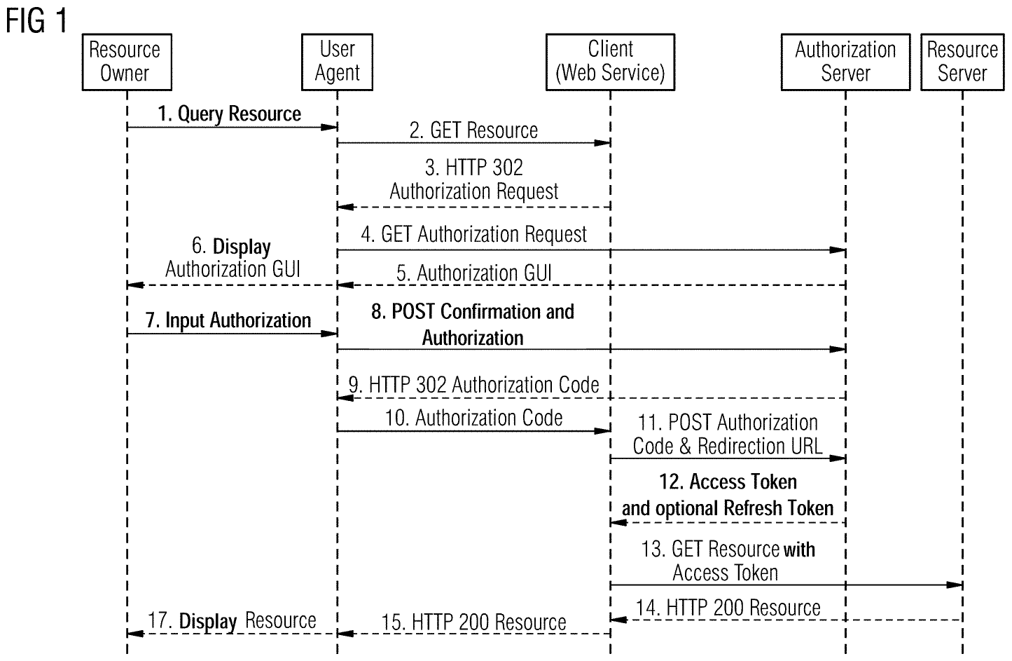

FIG. 2 depicts the mapping of data structures to graphs according to an embodiment.

FIG. 3 depicts a graph according to an embodiment.

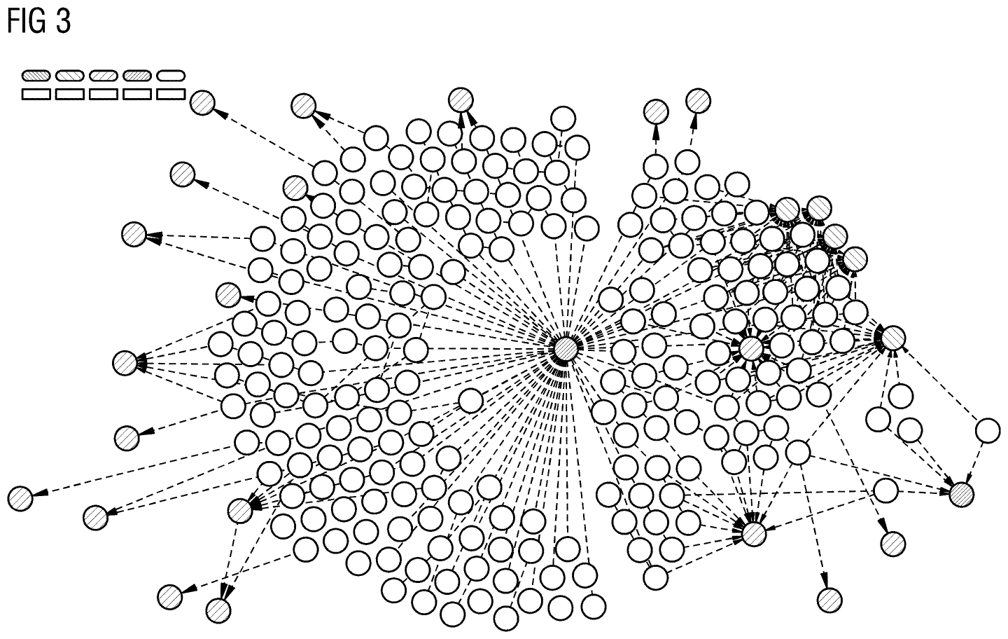

FIG. 4 depicts an architecture for implementing a method according to an embodiment.

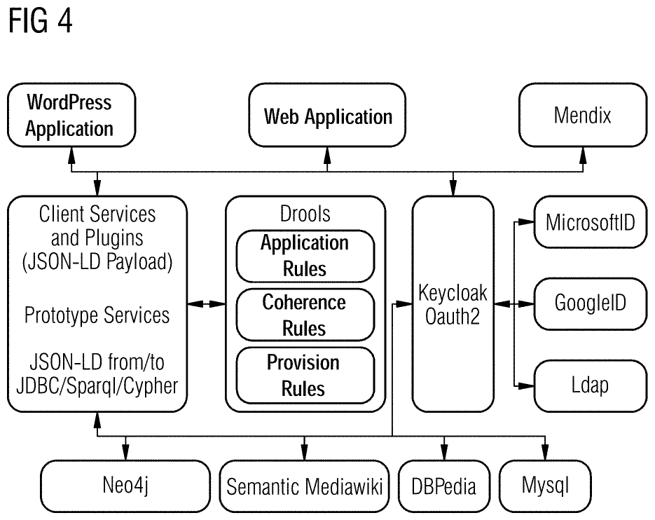

### DETAILED DESCRIPTION

The processing of graphs may start from specific solutions, that may be in sequential stages for example, for subproblems of the individual systems within the relevant data model.

A parallel processing may take place within the respective solution stage of the solution stages taking place in sequential stages.

For example, in the context of a MapReduce programming model (https://de.wikipedia.org/wiki/MapReduce, Feb. 27, 2020), a reduce step may be carried out after the MAP step.

When solving problems modeled using graphs, this may cause an unnecessary time and/or logical delay to occur, particularly in the case of cyclical graphs.

A distributed, knowledge-based, asynchronous processing of graphs may be simplified if an unambiguity of the edges and nodes is provided across the individual systems.

Individual systems may be coupled in a dedicated manner via direct interfaces or Enterprise Service Bus components and the data origin may be rendered identifiable in the target system using separate metadata and accessible for processing.

Alternatively, messages may be exchanged between the individual systems and the data in the target system adjusted as a result.

It may be desirable to improve the global coherence of the data compared to the two methods.

To this end, the data may be supplemented data with semantic information that may be read in an automated manner, and on the basis of the local identifiers of the data or data objects to establish a global unambiguity of the data or data objects.

Graphs may be globally configurable in relation to the logical historical and logical content-related criteria.

Unlike a local configuration approach, RMBS approaches with semantic ontologies (Web Ontology Language, OWL) may provide a global configuration option. Purely ontology-based rule systems, however, are limited to data formats in accordance with Resource Description Framework (RDF).

The two subgraphs may be provided in the form of stateless REST Web Service methods with JSON-LD.

One example of a description with JSON-LD may read:

\
″@context″: {
″name ″http://rdf data-vocabulary.orgMname”,
″ingredient″: ″http://rdf.data-vocabulary.orgMingredients″,
″yield″: ″http://rdfdata-vocabulary.Org/#yield″,
″instruct/ons”: ″http://rdf data-vocabulary’.orgMinstructions″.
″step”: {
″@id”: ″http://rdf.data-vocabulary.orgMstep″,
”@type″: ″xsd:integer″
},
description″: ″http://rdf.data-vocabulaty.org/Mescription″,
″xsd″: ″http://www.w3.org/2001/ XMLSchema#″
},
name″: ″Mojito″,
″ingredient”: [
″12 fresh mint leaves″,
″½ lime, juiced with pulp″,
”1 tablespoons white sugar″,
″1 cup ice cubes″,
″2 fluid ounces white rum″,
″½ cup club soda″
},
″yield″: ″1 cocktail″,
″instructions”: [
{
″step″: 1,
″description″: ″Crush lime juice, mint and sugar together in glass.″
}, ...

In an embodiment, the properties of the data objects, which properties are unambiguous locally in the subsystem that may also be considered the data source, may be rendered globally unambiguous by generating an Internationalized Resource Identifier (IRI).

For example, a locally unambiguous property, for example the personnel number 20002, may be converted into a global IRI, e.g., http://firma.de/personalsystem/Personalnummer/20002. The established DNS system may help provide the global unambiguity here.

Authentication and authorization information may be provided in a manner that is defined and decentralized via 0AUTH2 or SAML methods, in order to comply with data protection requirements.

The use of authentication and authorization information may make it possible for the control of the use of the data to remain at the source system.

Following authentication and authorization, the prepared subgraphs may be merged to form a complete graph at authenticated users by at least one merging rule. In this context, the merging rule may be ascertained directly via REST Web Services.

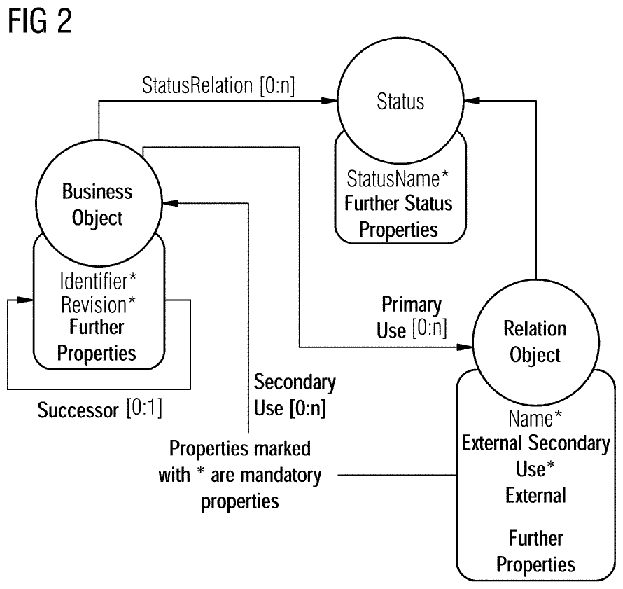

The data structures may be mapped via rule systems for example to graphs in accordance with the schematic diagram in FIG. 2.

Options for systems for storing the graphs, facts and rules that do not emerge from or in one of the linked systems include graph databases such as Cassandra or Neo4J or semantic triplestores, for example Fuseki/Jena. They are able to provide high flexibility and a good level of scalability, even with very large quantities of data.

The merging rules may be provided via dedicated or shared automatic rule systems (e.g., Drools/JBPM or semantic ontology-based rule systems (OWL reasoners)). Here, the provision of the data in the form of JSON-LD/RDF may prove highly flexible.

Advantageously, queries may be made to the rule systems in a stateless manner, wherein the automatic rule systems may themselves be stateful.

Complete graphs may again represent new subgraphs. The new subgraphs may be merged via secondary rule systems. The secondary rule systems may have coherence rules in particular. The secondary rule systems in turn are able to operate queries in a stateless manner, even if the automatic rule systems may themselves be stateful.

Furthermore, a rule-based processing of the complete graphs may take place.

The consistent use of stateless asynchronous requests in rule conditions and consequences, that is referred to as futures/promises depending on the programming language, may lead to a highly scalable application and execution of the application rules.

The semantic enrichment of the data via JSON-LD provides the cross-system logical configuration of the graphs.

Embodiments may moreover also provide derivation regarding historically/temporally logical relationships.

The use of domain model languages of BRMSs, such as Drools, may provide versatile rule formulations. A formulation of the relevant rules is provided inter alia which approximately corresponds to natural language.

One example of such a rule is given below:

(Drools)
import org. integrallis.drools. Message
expander say something, dsl
rule “ Rocky Balboa Says”
when
If there is a Person with name of “ Rocky Balboa”
And Person is at least 30 years old and lives in “ Philadelphia”
then
Say “Yo , Adrian!”
end
rule “Person means Tucson”
when
When there is a person living in a place with name that sounds like “ Two
then
Say “ You probably meant Tucson”
end
query> “Get all Messages”
get All Messages
end

It is to be understood that the elements and features recited in the appended claims may be combined in different ways to produce new claims that likewise fall within the scope of the present application. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present application has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method comprising:
providing at least two subgraphs; and
merging the at least two subgraphs to form a complete graph on a basis of at least one merging rule;
wherein when merging the at least two subgraphs on the basis of the at least one merging rule, a version of the at least one merging rule is stored.

2. The computer-implemented method of claim 1, wherein providing the at least two subgraphs comprises preparing raw data.

3. The computer-implemented method of claim 1, wherein providing the at least two subgraphs comprises authorization of an access to the at least two subgraphs.

4. The computer-implemented method of claim 3, wherein authorization of an access comprises using a Security Assertion Markup Language (SAML).

5. The computer-implemented method of claim 1, wherein providing the at least two subgraphs comprises providing the at least two subgraphs to an authenticated user.

6. The computer-implemented method of claim 1, wherein providing the at least two subgraphs comprises providing the at least two subgraphs as stateless REST Web Service methods with JSON-LD.

7. The computer-implemented method of claim 1, wherein the complete graph is stored in a semantic database.

8. The computer-implemented method of claim 1, wherein the at least one merging rule is provided by a dedicated automatic rule system.

9. The computer-implemented method of claim 2, wherein
preparing raw data comprises a creation of a semantic description of the raw data.

10. A non-transitory computer implemented storage medium that stores machine-readable instructions executable by at least one processor, the machine-readable instructions comprising:
providing at least two subgraphs; and
merging the at least two subgraphs to form a complete graph on a basis of at least one merging rule;
wherein when merging the at least two subgraphs on the basis of the at least one merging rule, a version of the at least one merging rule is stored.

11. The non-transitory computer implemented storage medium of claim 10, wherein providing the at least two subgraphs comprises preparing raw data.

12. The non-transitory computer implemented storage medium of claim 10, wherein providing the at least two subgraphs comprises authorization of an access to the at least two subgraphs.

13. The non-transitory computer implemented storage medium of claim 12, wherein authorization of an access comprises using a Security Assertion Markup Language (SAML).

14. The non-transitory computer implemented storage medium of claim 10, wherein providing the at least two subgraphs comprises providing the at least two subgraphs to an authenticated user.

15. The non-transitory computer implemented storage medium of claim 10, wherein providing the at least two subgraphs comprises providing the at least two subgraphs as stateless REST Web Service methods with JSON-LD.

16. The non-transitory computer implemented storage medium of claim 10, wherein the complete graph is stored in a semantic database.

17. The non-transitory computer implemented storage medium of claim 10, wherein the at least one merging rule is provided by a dedicated automatic rule system.

18. The non-transitory computer implemented storage medium of claim 11, wherein
preparing raw data comprises a creation of a semantic description of the raw data.
